(19) United States
(12) Patent Application Publication
(10) Pub. No.: US 2024/0307987 A1
(43) Pub. Date: Sep. 19, 2024

(54) Tap

(71) Applicant: NACHI-FUJIKOSHI CORP., Tokyo (JP)

(72) Inventors: Yuuki KURITA, Toyama-shi (JP); Hiroki OGUME, Toyama-shi (JP); Itaru YAMAZAKI, Toyama-shi (JP)

(21) Appl. No.: 18/645,935

(22) Filed: Apr. 25, 2024

Related U.S. Application Data
(63) Continuation of application No. PCT/JP2022/044077, filed on Nov. 30, 2022.

(30) Foreign Application Priority Data
Dec. 2, 2021 (JP) 2021-195984

(51) Int. Cl. B23G 5/06

(52) U.S. Cl. CPC B23G 5/06

(57) ABSTRACT

A tap including an incomplete thread having a plurality of thread ridges that threads a workpiece, a complete thread including a cutting edge formed continuously from the incomplete thread, and a groove part that is disposed in each of the incomplete thread and the complete thread to discharge chips of the workpiece, wherein relationships respectively expressed by Equation (1): D1≥D0−P and Equation (2): h≤P/2 are simultaneously satisfied in a relationship among a nominal diameter D0 of the tap 100, a root diameter D1, a pitch P, and a thread ridge height h.

### CROSS REFERENCE TO RELATED APPLICATIONS

This application is a continuation of International Patent Application No. PCT/JP2022/044077, having an international filing date of Nov. 30, 2022, which designated the United States, the entirety of which is incorporated herein by reference. Japanese Patent Application No. 2021-195984 filed on Dec. 2, 2021 is also incorporated herein by reference in its entirety.

### BACKGROUND OF THE INVENTION

Threading has been so far performed using a dedicated tool so-called tap when performed by cutting. Cutting is performed by a leading part or an incomplete thread corresponding to a tip portion of the tap, and chips that have been generated by the cutting are fed to a complete thread on the rear end side of the tap through a groove (helical flute) and are discharged outward. In this case, the generated chips are spirally formed, and have a relatively constant length. Accordingly, a portion of the complete thread is chamfered, as described in WO-2008-075402, WO 2008-136123, JP-A-2008-272856, JP-U-H10-286723 and JP-B-2813173, for example, so that the chips can be discharged more quickly.

On the other hand, a root part is formed between thread parts included in the incomplete thread in the tap, and a groove bottom of the root part is formed of a very small curve. That is, cutting by the incomplete thread is not performed in the root part (particularly, the groove bottom). Accordingly, there has been a problem that when a work material is intermittently cut, a burr is generated in the periphery of a threaded hole for some of worked materials.

To solve such a problem, it has been disclosed that generation of burrs around a threaded hole of a work material is suppressed by making a tap have a shape that also enables cutting in a root part (particularly, a groove bottom) in its incomplete thread to perform a so-called forming work for the entire incomplete thread (see WO-1997-026106).

However, when cutting is performed by an entire incomplete thread, chips become longer and their curl diameter becomes larger than those in a case where a conventional tap is used, thereby presenting a problem that a cutting edge is chipped or chipping occurs due to engagement of the chips in a complete thread corresponding to the rear end side of the tap when the chips are discharged outward.

### BRIEF DESCRIPTION OF THE DRAWINGS

FIG. 1 is a front view of a tap 100 (a first embodiment) according to the present disclosure.

FIG. 2 is a left side view of the tap 100 illustrated in FIG. 1.

FIG. 3 is a perspective view of the tap 100 illustrated in FIG. 1.

FIG. 4 is a schematic sectional view of a tip portion of the tap 100 according to the present disclosure.

FIG. 5 is a schematic sectional view parallel to a rotational axis of a tap 200 (a second embodiment) according to the present disclosure.

FIG. 6 is a schematic sectional view parallel to a rotational axis of a tap 300 (a third embodiment) according to the present disclosure.

FIG. 7 is an enlarged view of the tip portion of the tap 100 illustrated in FIG. 1.

FIG. 8 is a cross-sectional view taken along a line A-A in the tap 100 illustrated in FIG. 7.

FIG. 9 is a cross-sectional view taken along a line B-B in the tap 100 illustrated in FIG. 7.

FIG. 10 is an enlarged view of a tip portion of a tap 400 (a fourth embodiment) according to the present disclosure.

FIG. 11 is a cross-sectional view taken along a line C-C in the tap 400 illustrated in FIG. 10.

FIG. 12 is a cross-sectional view taken along a line D-D in the tap 400 illustrated in FIG. 10.

FIG. 13 is a schematic sectional view of a workpiece by cutting using an example product 1 in an example 1.

FIG. 14 is a schematic sectional view of a workpiece by cutting using a conventional product.

### DETAILED DESCRIPTION

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

The present disclosure has as its object to provide a tap capable of also preventing a cutting edge in a complete thread from being chipped due to chips that are generated when performing cutting by an entire incomplete thread corresponding to a tip portion of the tap.

To solve the above-referenced object, a tap in accordance with one of some embodiments includes an incomplete thread having a plurality of thread ridges that threads a workpiece, a complete thread including a cutting edge formed continuously from the incomplete thread, and a groove part that is disposed in each of the incomplete thread and the complete thread to discharge chips of the workpiece, in which relationships respectively expressed by the following expressions (1) and (2) are simultaneously satisfied in a relationship among a nominal diameter D0 of the tap, a root diameter D1, a pitch P, and a thread ridge height h:

$$D 1 \geq D 0 - P , and \qquad ( 1 )$$

$$h \leq P / 2. \qquad ( 2 )$$

The cutting edges in the complete thread can be chamfered. Particularly, the cutting edges at a second and subsequent thread ridges in the complete thread are preferably chamfered. In this case, the cutting edges in the whole or part of a portion excluding roots in the complete thread are more preferably chamfered.

A tap in accordance with one of some embodiments produces an effect of being able to also prevent cutting edges in a complete thread from being chipped due to chips that are generated when performing cutting by an entire incomplete thread corresponding to a tip portion of the tap.

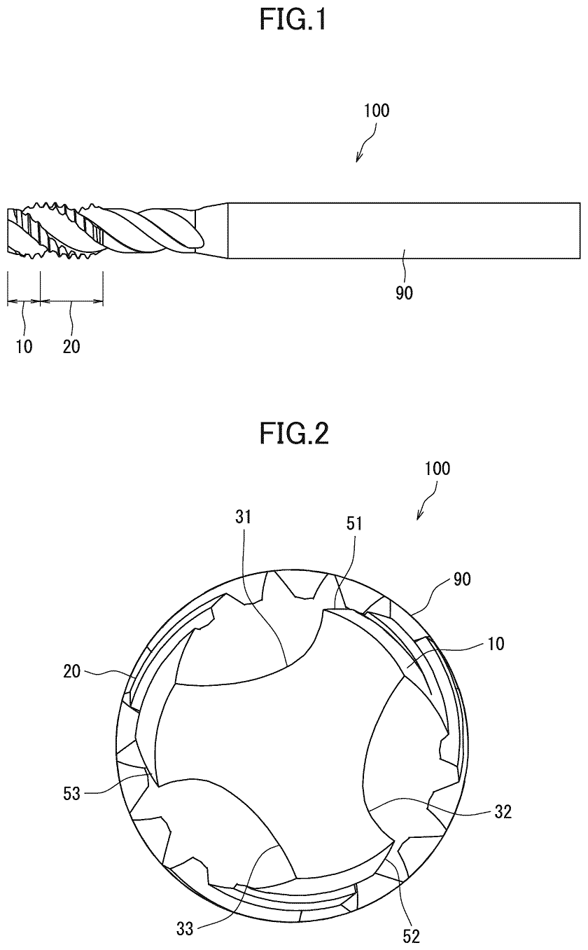

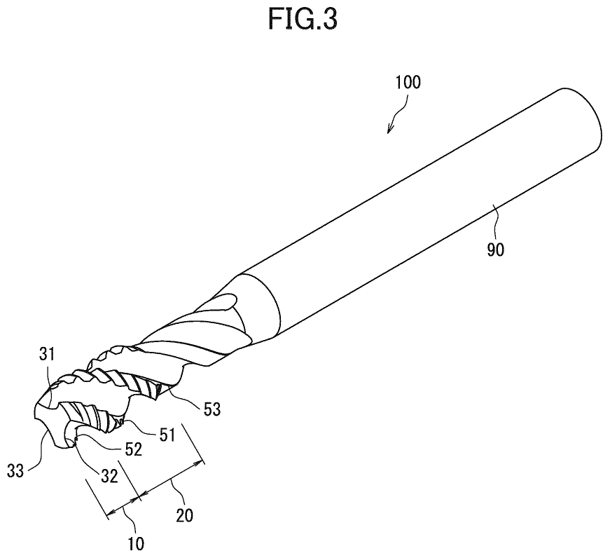

Various embodiments of a tap according to the present disclosure will be described with reference to the drawings. FIGS. 1, 2, and 3 respectively illustrate a front view of a tap 100 according to a first embodiment of the present disclosure, a left side view of the tap 100 according to the first embodiment illustrated in FIG. 1, and a perspective view of the tap 100 according to the first embodiment illustrated in FIG. 1. The tap 100 according to the first embodiment of the present disclosure broadly includes an incomplete thread 10 on the tip end side that first threads a workpiece, a complete thread 20 formed continuously from the incomplete thread 10, and a shank 90 that is positioned on the rear end side of the tap 100 and serves as a grip part when attached to a machine tool, as illustrated in FIGS. 1 and 3.

From the incomplete thread 10 to the complete thread 20 included in the tap 100, cutting edges 51, 52, and 53 continuously formed are formed, as illustrated in FIGS. 1 to 3. A plurality of groove parts 31, 32, and 33 spirally formed are arranged on the front side in a rotational direction (a clockwise direction in FIG. 2) of the tap 100 to be adjacent to the cutting edges 51, 52, and 53 in an axial direction (longitudinal direction) of the tap 100, as illustrated in FIGS. 2 and 3.

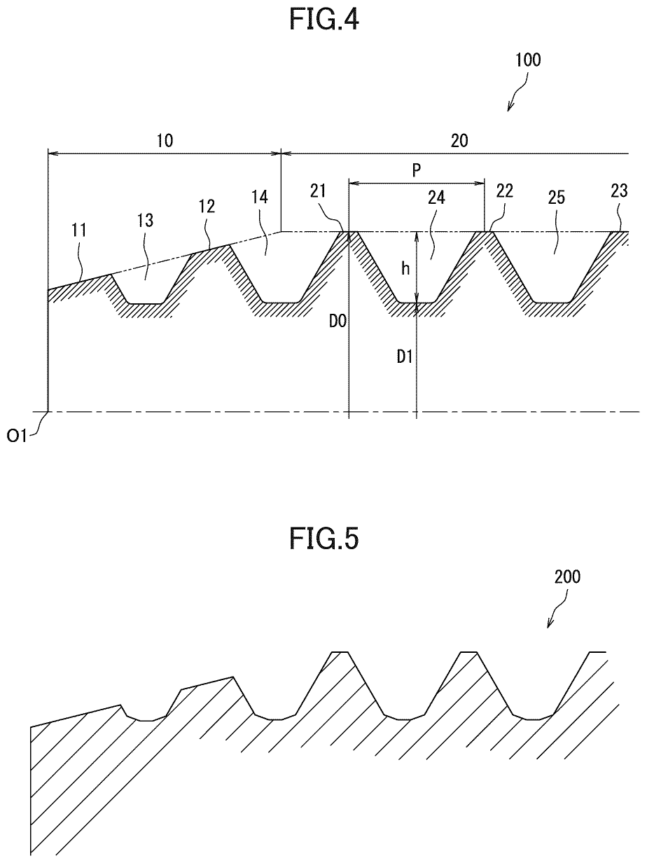

FIG. 4 illustrates a schematic sectional view (a diagram illustrating an upper half from a rotational axis O1 in the tap 100). in the axial direction along a root between thread ridges from the incomplete thread 10 to the complete thread 20 in the tap 100 illustrated in FIGS. 1 to 3 The tap 100 according to the first embodiment of the present disclosure includes a plurality of thread ridges 11 and 12 forming a portion of the incomplete thread 10 and a plurality of thread ridges 21, 22, and 23 forming a portion of the complete thread 20 from the left side to the right side of the drawing, as illustrated in FIG. 4. Simultaneously, in the axial direction of the tap 100, root parts 13 and 14 and root parts 24 and 25 are respectively formed between the two adjacent thread ridges 11 and 12 in the incomplete thread 10 and among the three adjacent thread ridges 21, 22, and 23 in the complete thread 20.

In the tap 100 according to the present disclosure, both the following expressions (1) and (2) hold:

$$D 1 \geq D 0 - P , and \qquad ( 1 )$$

$$h \leq P / 2 , \qquad ( 2 )$$

where D0 is a nominal diameter of the tap 100, D1 is a diameter of a root (root diameter) in a root part, P is a pitch between thread ridges, and h is a thread ridge height (a dimension from the root to a crest of each of the thread ridges), as illustrated in FIG. 4.

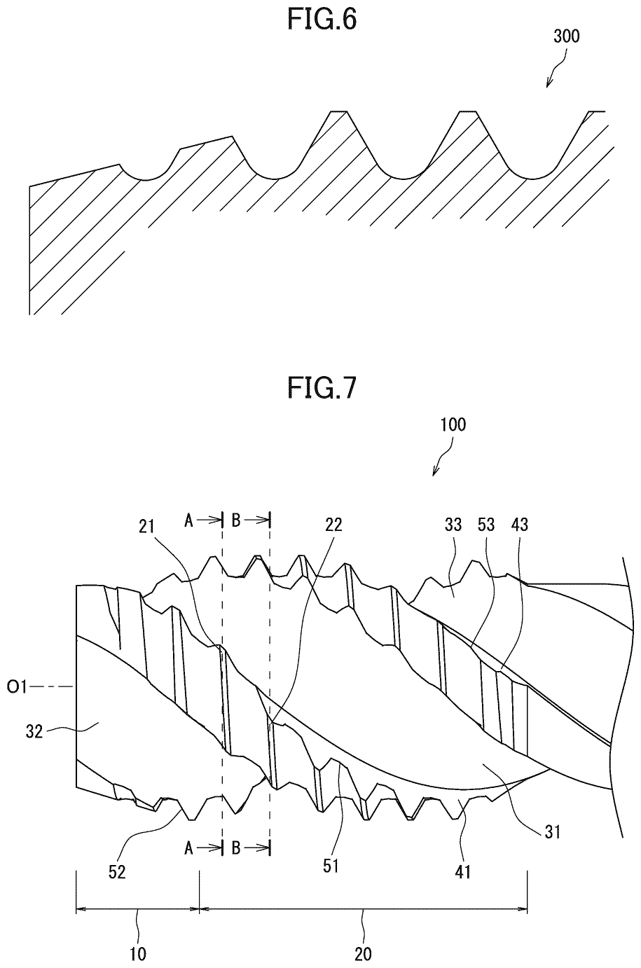

Although, each of the root parts 13, 14, 24, and 25 in the tap 100 (the first embodiment) illustrated in FIG. 4 is formed of a straight line parallel to the rotational axis O1 when seen in a sectional view along the root in the tap 100, each of the root parts may be formed of a plurality of straight lines like in a tap 200 (a second embodiment) illustrated in FIG. 5, or may be formed of a curve like in a tap 300 (a third embodiment) illustrated in FIG. 6, as long as the foregoing expressions (1) and (2) are simultaneously satisfied.

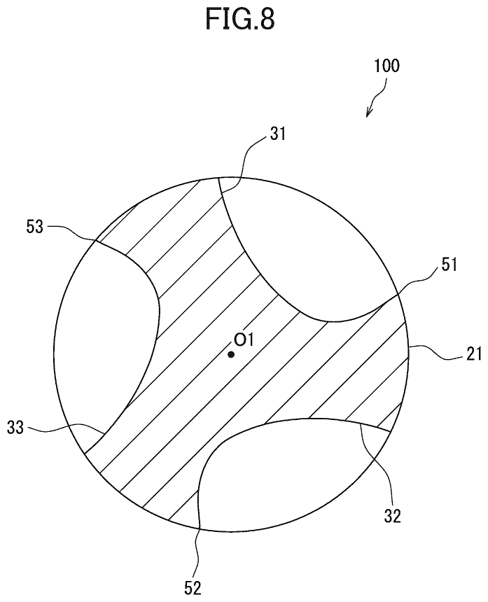

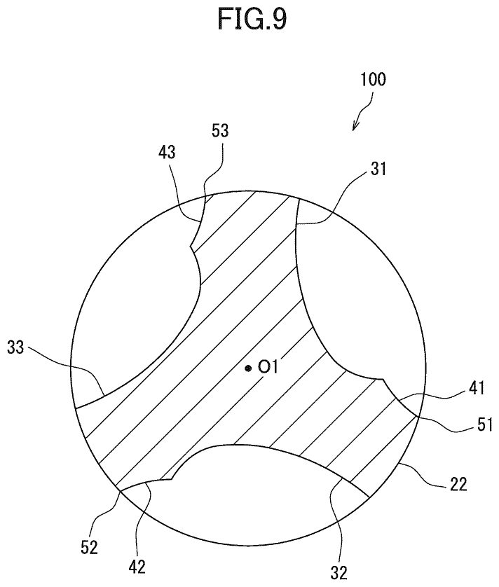

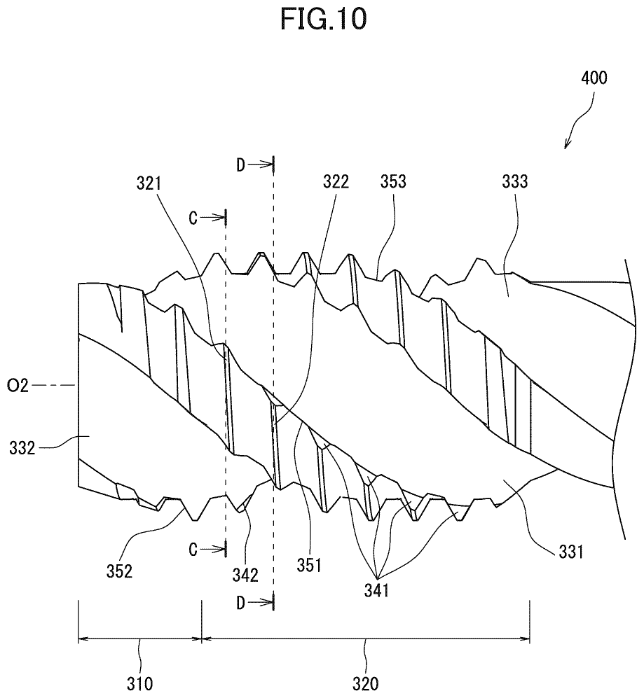

FIG. 7 illustrates an enlarged view of a tip portion of the tap 100 (the first embodiment) illustrated in FIG. 1, FIG. 8 illustrates a cross-sectional view taken along a line A-A of the first thread ridge 21 in the complete thread 20 illustrated in FIG. 7, and FIG. 9 illustrates a cross-sectional view taken along a line B-B of the second thread ridge 22 in the complete thread 20. In the tap 100, a chamfered part (chamfer part) does not exist in the cutting edge 51 at the first thread ridge 21 in the complete thread 20, as illustrated in FIGS. 7 and 8.

On the other hand, at the second thread ridge 22 and subsequent thread ridges in the complete thread 20, chamfer parts 41, 42, and 43 are respectively formed along the helical flutes 31, 32, and 33 in the entire cutting edges 51, 52, and 53, as illustrated in FIGS. 7 and 9. That is, each of the entire cutting edges at the second and subsequent thread ridges in the complete thread in the tap is chamfered, thereby making it possible to prevent the cutting edge in the complete thread from being chipped (broken) during threading.

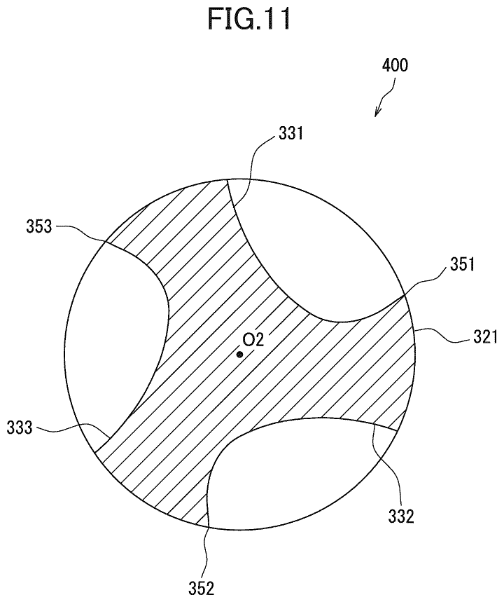

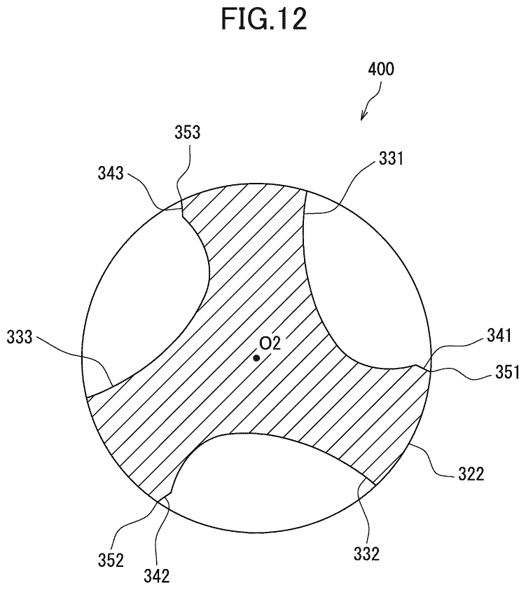

Then, FIG. 10 illustrates an enlarged view of a tip portion of a tap 400 according to a different embodiment (a fourth embodiment) of the present disclosure, FIG. 11 illustrates a cross-sectional view taken along a line C-C of a first thread ridge 321 in a complete thread 320 in the tap 400 illustrated in FIG. 10, and FIG. 12 illustrates a cross-sectional view taken along a line D-D of a second thread ridge 322 in the complete thread 320 in the tap 400 illustrated in FIG. 10. In the tap 400, a chamfered part (chamfer part) does not exist either in a cutting edge 351 at the first thread ridge 321 in the complete thread 320, as illustrated in FIGS. 10 and 11, as like in the tap 100 according to the first embodiment.

On the other hand, at a second thread ridge 322 and subsequent thread ridges in the complete thread 320, chamfer parts 341, 342, and 343 are each formed in a dispersed manner in a plurality of portions, respectively, along helical flutes 331, 332, and 333 in cutting edges 351, 352, and 353, as illustrated in FIGS. 10 and 12. In this case, each of the cutting edges 351, 352, and 353 is chamfered in a portion excluding roots in the complete thread. As in the present embodiment, the cutting edges at the second and subsequent thread ridges in the complete thread in the tap are chamfered, thereby making it possible to prevent the cutting edge in the complete thread from being chipped (broken) during threading, as like in the tap 100 according to the first embodiment. Example

Cutting tests were respectively performed using two types of taps according to the present disclosure (hereinafter referred to as an “example product 1” and an “example product 2”) and a conventional tap (hereinafter referred to as a “conventional product”), to confirm cutting performances of the taps. A specification of a tap nominal diameter M6 and a pitch P=1.0 mm was made common between both the example products 1 and 2 and the conventional product respectively used in the cutting tests. A root diameter (D1) in the example products 1 and 2 was set to 5.050 mm (a thread ridge height h: 0.475 mm), and a root diameter (D1) in the conventional product was set to 4.684 mm (a thread ridge height h: 0.658 mm). Further, cutting edges at second and subsequent thread ridges in a complete thread in the example product 2 were subjected to similar chamfering to that in the tap (the fourth embodiment) illustrated in FIGS. 10 to 12.

Working conditions of the cutting tests were as follows:
work material: carbon steel (S50C)
drill hole diameter: 5.0 mm
cutting speed: 30.0 (m/min)
number of revolutions: 1592 (1/min)
feeding speed: 1592 (mm/min)
effective thread length: 2D (12 mm)
cutting oil: water-soluble cutting fluid
used machine: vertical MC

The cutting tests were started under the above-referenced working conditions, and cutting was continuously performed until a working abnormality was confirmed, for example, when chipping was confirmed in the cutting edge in each of the used taps or when a working sound amount rapidly increased. After these phenomena were confirmed, the tests were finished to observe a state of the work material and a surface state of the used tap.

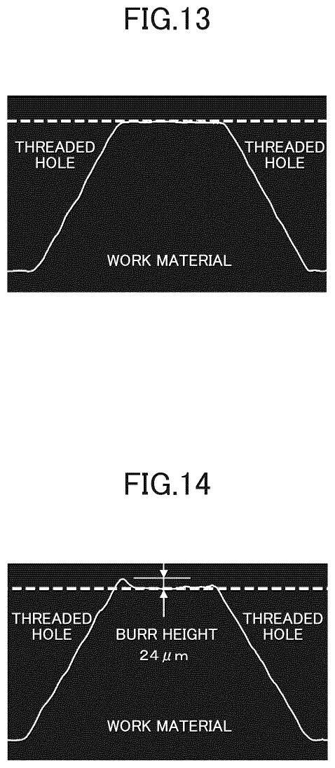

In the cutting tests, an abnormal sound was confirmed in the test using the conventional product at a time point where a cumulative number of worked holes from the start of the test was 1200. Accordingly, at the time point, the cutting tests respectively using the example product 1 and the example product 2 were also all finished. After the tests were finished, a state of an inner portion of the work material at the time point and a state of a cutting edge or the like in each of the used taps were confirmed. FIG. 13 illustrates a state of a thread ridge of the work material by cutting using the example product 1 after the cutting test was finished (at the time point where the cumulative number of worked holes was 1200) and FIG. 14 illustrates a state of a thread ridge of the work material by cutting using the conventional product. Each of the drawings illustrated in FIGS. 13 and 14 is an image obtained by cutting the work material in a depth direction of a threaded hole after the cutting test was finished to scan a ridge line of a specific thread ridge using a three-dimensional measurement device.

First, as a result of measuring a state of a thread ridge (ridge line) cut by the example product 1, generation of a burr, a flash, or the like in the thread ridge was not confirmed, as illustrated in FIG. 13. On the other hand, in a state of a thread ridge cut by the conventional product, generation of a burr having a height of approximately 24 μm was confirmed in the thread ridge, as illustrated in FIG. 14. This is estimated to be because a relationship among a nominal diameter (D0), a root diameter (D1), a pitch (P), and a thread ridge height (h) in the example product 1 satisfies the above-referenced relationships respectively expressed by the expressions (1) and (2), in other words, to be due to an effect of making a dimension of the root diameter larger than that in the conventional product.

Then, when respective states of the cutting edges in the example products after the cutting tests were finished were observed, chipping of the cutting edge was not confirmed in the example product 2. On the other hand, chipping (breakage of the cutting edge) was confirmed in a portion of the cutting edge in each of the complete threads in the conventional product and the example product 1. This can be estimated to be due to an effect of chamfering the cutting edge (particularly, at the second and subsequent thread ridges) in the complete thread in addition to being because a specification of the example product 2 satisfies the above-referenced relationships respectively expressed by the expressions (1) and (2).

A tap according to the present disclosure is excellent in tapping accuracy because it can also prevent a cutting edge in a complete thread from being chipped when performing cutting by an entire incomplete thread.

This enables applications to various types of taps.

What is claimed is:

1. A tap comprising:
an incomplete thread having a plurality of thread ridges that threads a workpiece;
a complete thread including cutting edges formed continuously from the incomplete thread; and
a groove that is disposed in each of the incomplete thread and the complete thread to discharge chips of the workpiece,
wherein relationships respectively expressed by the following expressions (1) and (2) are simultaneously satisfied in a relationship among a nominal diameter D0 of the tap, a root diameter D1, a pitch P, and a thread ridge height h:
$$D 1 \geq D 0 - P , and \qquad ( 1 )$$
$$h \leq P / 2. \qquad ( 2 )$$

2. The tap according to claim 1, wherein the cutting edges in the complete thread are subjected to chamfering.

3. The tap according to claim 2, wherein the cutting edges at a second and subsequent thread ridges in the complete thread are subjected to the chamfering.

4. The tap according to claim 2, wherein the cutting edges in the whole or part of a portion excluding roots in the complete thread are subjected to the chamfering.

5. The tap according to claim 3, wherein the cutting edges in the whole or part of a portion excluding roots in the complete thread are subjected to the chamfering.
